(19) United States
(12) Patent Application Publication
(10) Pub. No.: US 2011/0075596 A1
(43) Pub. Date: Mar. 31, 2011

(54) Resource Overbooking

(75) Inventors: Orlando M.P.R. Moreira, Eindhoven (NL); David Van Kampen, Eindhoven (NL); Antti-Veikko Sakari Piipponen, Tampere (FI); Tommi J. Zetterman, Espoo (FI)

(73) Assignee: Nokia Corporation

(21) Appl. No.: 12/567,150

(22) Filed: Sep. 25, 2009

(51) Int. Cl. H04B 7/00

(52) U.S. Cl. 370/310

(57) ABSTRACT

In a multi-radio device it is determined that a first radio application requests change to a first operational state during a time at which a second radio application is in or requests a second operational state. A local memory is accessed to determine a first and a second budget of resources for the respective first and second operational states of the respective first and second radio applications. There is at least one common resource among the first and second budgets. From resource allocation rules stored in the memory is determined that each of the common resources are mutually exclusive as between the first and second operational states of the respective first and second radio applications. As a result of the determining from the resource allocation rules, the request of the first radio application is granted by allocating resources according to the first budget for the first operational state while resources according to the second budget are allocated for the second operational state.

### CROSS REFERENCE TO RELATED APPLICATIONS

This application concerns subject matter related to that described in co-owned U.S. patent applications Ser. No. 11/731,084 (filed Mar. 30, 2007); Ser. No. 12/319,125 (filed Dec. 30, 2008); and co-owned U.S. Provisional Patent Application 61/197,882 (filed Oct. 30, 2008).

### TECHNICAL FIELD

The exemplary and non-limiting embodiments of this invention relate generally to wireless communication systems, methods, devices and computer programs and, more specifically, relate to real-time scheduling of computation of multiple data streams in a wireless multi-radio device such as a software defined radio, for example multimedia processing or radio baseband signal processing chains.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

BB baseband

CPU central processing unit

FEM front-end modules

HW hardware

IF interface

MRC multiradio controller

RA radio application

RF radio frequency

RM resource manager

RSS received signal strength

RT real-time

SDF synchronous data flow

SDR software defined radio

SW software

URSI unified radio system interface

In software defined radios (SDR), the Radio Frequency (RF) hardware (HW) is typically used as a radio transceiver for variable radio standards or systems, such as GSM (global system for mobile communication), WCDMA (wideband code division multiple access), WLAN (wireless local area network), BT (Bluetooth), DVB-H (digital video broadcast for handheld devices), WiMax (wireless broadband), GPS (global positioning system), and Galileo, to name a few non-limiting examples. This raises a need for general-purpose, configurable RF HW blocks that are capable of operating with the widely distinct requirements of different radio standards. This need for a wide range of configurability and tunability options increases the number of different configuration options which have to be modified when configuration settings are changed. This means a greater number of configuration settings that are required to reconfigure the shared RF HW blocks for the different radio modes.

Like a conventional computer, a SDR is a computer that has to be able to execute multiple concurrent applications. Radio spectrum may be the most critical resource which active radio applications need to access. However, the radio spectrum may suffer from interoperability problems. Typical sources of interoperability problems include wide band noise from frequency synthesizers and/or power amplifiers, harmonics, intermodulation of two or more transmitters, RF blocking (desensitization) and clock leakage, to name but a few.

Traditional radio implementations may use statically allocated resources (even dedicated resources) to guarantee proper operation. Many radio applications may be developed assuming the use of a dedicated portion of the shared resources (for example, memory, CPU cycles, etc.)

A dynamic resource manager may provide resource allocations and de-allocations when radio applications are loaded and unloaded to/from the program execution framework. If resources are guaranteed for the running applications, loading of a new application might fail due to a lack of resources. Otherwise radio applications, not knowing the resource situation, could run into unexpected problems when their resources are unavailable or taken by other radio applications.

Alternatively, the guaranteed resource requirements of a radio application may be based on a “worst-case” situation in order to assure the applications do not exceed their allocated share (which could lead to catastrophic results). Using ‘worst-case’ situations for a radio application will likely lead to wasted resources as the individual radio applications likely do not use all their allocated resources all of the time for which they are allocated.

In a hard-real time system, whether SDR or otherwise, resources are typically allocated unconditionally to each job/radio application, i.e. the resources are available to it always, and cannot be used by any other job even if the job to which they were allocated is not utilizing them. Consider a conceptually simple example in the RF domain. Assume a WLAN and a Bluetooth radio both use the same physical SDR antenna for transmissions. During the time that antenna is allocated to a WLAN transmit job it cannot simultaneously be allocated to any Bluetooth transmit job. Such an overlap in time would necessarily lead to failure of one or both of the transmissions. So long as both WLAN and Bluetooth transmissions from the SDR use the same physical antenna as is assumed in this example, there cannot be simultaneous transmissions in both systems. This is somewhat a function of the WLAN and Bluetooth wireless standards, which stipulate the appropriate frequency bands for transmission. Having only one transmit antenna which can transmit in those required transmit bands, a conventional SDR multi-radio scheduler must schedule the WLAN transmission job so as not to overlap in time the Bluetooth transmission job. From this simple example it is clear that the problem also exists for other shared hardware (e.g., storage registers, encoders, samplers, buses which transfer data, CPU cycles), as well as processes in different hardware components that cause interference with one another (e.g., different physical antennas which would interfere with each other if they each transmitted simultaneously).

The entity managing the various resources is termed the resource manager, whether those resources are HW or radio spectrum usage. The resource manager must assume that all active jobs may require all of their allocated resources at any time when doing admission control for a new job. As will be detailed below, this may cause a huge amount of resource waste.

Some relevant background teachings on SDR and resource allocation may be seen at the following papers: Moreira, O. et al, “Online resource management on a multiprocessor with a network-on-chip” (PROCEEDINGS OF THE ACM SYMPOSIUM ON APPLIED COMPUTING, 2007); Moreira, O. et al, “Multiprocessor Resource Allocation for Hard-Real-Time Streaming with a Dynamic Job-Mix” (PROCEEDINGS OF THE IEEE RTAS, 2005); Goossens, K. et al, “Chapter 4: Guaranteeing the quality of service in networks on chip” (NETWORKS ON CHIP, pp 61-82, Kluwer, 2004) and Ahtiainen, A. et al, “Multiradio Scheduling and Resource Sharing on a Software Defined Radio Computing Platform” (PROCEEDINGS OF THE SDR FORUM TECHNICAL CONFERENCE, October 2008).

### SUMMARY

The foregoing and other problems are overcome, and other advantages are realized, by the use of the exemplary embodiments of this invention.

In a first aspect thereof the exemplary embodiments of this invention provide a method comprising determining that a first radio application of a multi-radio device requests change to a first operational state for a time at which a second radio application of the multi-radio device is in a second operational state or requests to be in the second operational state; accessing a local memory to determine a first budget of resources for the requested first operational state of the first radio application and also to determine a second budget of resources for the second operational state of the second radio application, for the case in which there is at least one resource in common among the first budget and the second budget, determining from resource allocation rules stored in the local memory that each of the common resources are mutually exclusive as between the first operational state of the first radio application and the second operational state of the second radio application. Further in the method and as a result of the determining from the resource allocation rules, granting the request of the first radio application by allocating resources according to the first budget for the first operational state of the first radio application during the time at which resources according to the second budget are allocated for the second operational state of the second radio application.

In a second aspect thereof the exemplary embodiments of this invention provide a memory storing computer readable instructions that when executed by a processor perform operations. In this aspect the actions comprise determining that a first radio application of a multi-radio device requests change to a first operational state for a time at which a second radio application of the multi-radio device is in a second operational state or requests to be in the second operational state; accessing a local memory to determine a first budget of resources for the requested first operational state of the first radio application and also to determine a second budget of resources for the second operational state of the second radio application, for the case in which there is at least one resource in common among the first budget and the second budget, determining from resource allocation rules stored in the local memory that each of the common resources are mutually exclusive as between the first operational state of the first radio application and the second operational state of the second radio application. Further in the method and as a result of the determining from the resource allocation rules, granting the request of the first radio application by allocating resources according to the first budget for the first operational state of the first radio application during the time at which resources according to the second budget are allocated for the second operational state of the second radio application.

In a third aspect thereof the exemplary embodiments of this invention provide an apparatus comprising at least one processor (e.g., a resource manager for a multi-radio device, or more generally radio resource management means, which in the non-limiting examples can be the resource manager 118 and/or the multi-radio controller 116) and a memory storing a first budget of resources for a first operational state of a first radio application, a second budget of resources for a second operational state of a second radio application, and a set of resource allocation rules (or more generally the memory is computer readable storing means). In this aspect of the invention, the at least one processor is configured to determine that a first radio application of the multi-radio device requests change to a first operational state for a time at which a second radio application of the multi-radio device is in a second operational state or requests to be in the second operational state. The at least one processor is configured to access the memory to determine the first and the second budget. For the case in which there is at least one resource in common among the first budget and the second budget, and in which the at least one processor determines from the resource allocation rules stored in the memory that each of the common resources are mutually exclusive as between the first operational state of the first radio application and the second operational state of the second radio application, then as a result of the determining from the resource allocation rules the at least one processor is configured to grant the request of the first radio application by allocating resources according to the first budget is also configured to allocate resources according to the first budget for the first operational state of the first radio application during the time at which resources according to the second budget are allocated for the second operational state of the second radio application.

### BRIEF DESCRIPTION OF THE DRAWINGS

FIG. 1 depicts an exemplary SDR function architecture.

FIG. 2 shows a simplified example block diagram of the timing concept in MRC scheduling.

FIG. 3 illustrates a simplified example diagram of a multiradio scheduling timeline.

FIG. 4 illustrates a simplified block diagram of an exemplary radio computer platform.

FIG. 5 shows a simplified block diagram of an exemplary radio system resource usage.

FIG. 6 is a schematic block diagram showing an exemplary resource overbooking process according to an exemplary embodiment of the invention.

FIG. 7 is a logic flow diagram that illustrates the operation of a method, and a result of execution of computer program instructions embodied on a computer readable memory, in accordance with the exemplary embodiments of this invention.

FIG. 8 shows a simplified block diagram of a user equipment that is suitable for use in practicing the exemplary embodiments of this invention.

### DETAILED DESCRIPTION

Underlying the concept of these teachings is the condition that, either because of their interaction or resource conflicts in other subsystems, two particular jobs which the resource scheduler detailed in background above schedules to overlap in time may in fact not really be using all their allocated resources at the same instant. From this it follows that a more efficient use of the resources can be achieved by looking more particularly at what resources are being accessed by the individual jobs at what instant of time. By developing a set of mutual exclusivity rules, the resource scheduler can allocate resources to different jobs at the same time, jobs which in the prior art would have to be separated in time. In this manner the resources are ‘overbooked’ in that shared or interfering resources are allocated to different jobs that run simultaneously. There is an increased granularity in that mutual exclusivity rules reflect specific resource accesses at specific times by the different jobs. This enables the resource scheduler to schedule/admit simultaneous/time overlapping jobs that the prior art could not.

In the WLAN/Bluetooth shared antenna example above, the WLAN transmit job may in fact not access the shared antenna at certain instances during its transmission job (e.g., during a guard interval), and a relatively fast Bluetooth transmission (e.g., a periodic synchronization word sent to the slaved units) might be small enough to squeeze into that guard period during which the admitted WLAN transmit job does not actually use the shared antenna. This example also assumes that no matter how mis-aligned the WLAN and Bluetooth transmission frames may be, there will always be a WLAN guard period which falls within the time window which the Bluetooth synch word is to be sent (but this is not a necessary precondition, as will be detailed below). The mutual exclusivity rules in this example would allow the resource scheduler to schedule/admit (e.g., to allocate resources for) the Bluetooth synch word transmission job while the WLAN transmit job was scheduled (assuming of course there is no other conflict to deny scheduling the simultaneous jobs). Said another way, a mutual exclusivity rule for this example would stipulate that the WLAN transmit job and the Bluetooth synch word transmit job are mutually exclusive. The SDR knows this because the resource allocation rules for the WLAN transmissions which are stored in the SDR memory are mutually exclusive of the resource allocation rules for the Bluetooth synch word transmission, also stored in the SDR memory. Both jobs can be allocated at the same time (assuming no other resource conflicts).

A similar case can be made when there are separate WLAN and Bluetooth antennas but they both cannot be used simultaneously due to RF interference with one another. The antenna resources, though distinct, are subject to mutually exclusive use, only when the other antenna is not in use at that access instant.

The above antenna example is non-limiting. The same principle can be applied to other shared RF hardware such as for example shared analog/RF signal paths and/or specific amplifiers, mixers, filters with adjustable frequency response, and so forth that make up such a path. Any individual ‘job’ is an operational state of a radio application, and each job has a resource budget defining all the resources needed for that job to run. In that respect, clearly the resources in any particular budget depend on the job under consideration, and so are not limited to RF only but also extend to baseband processing and others.

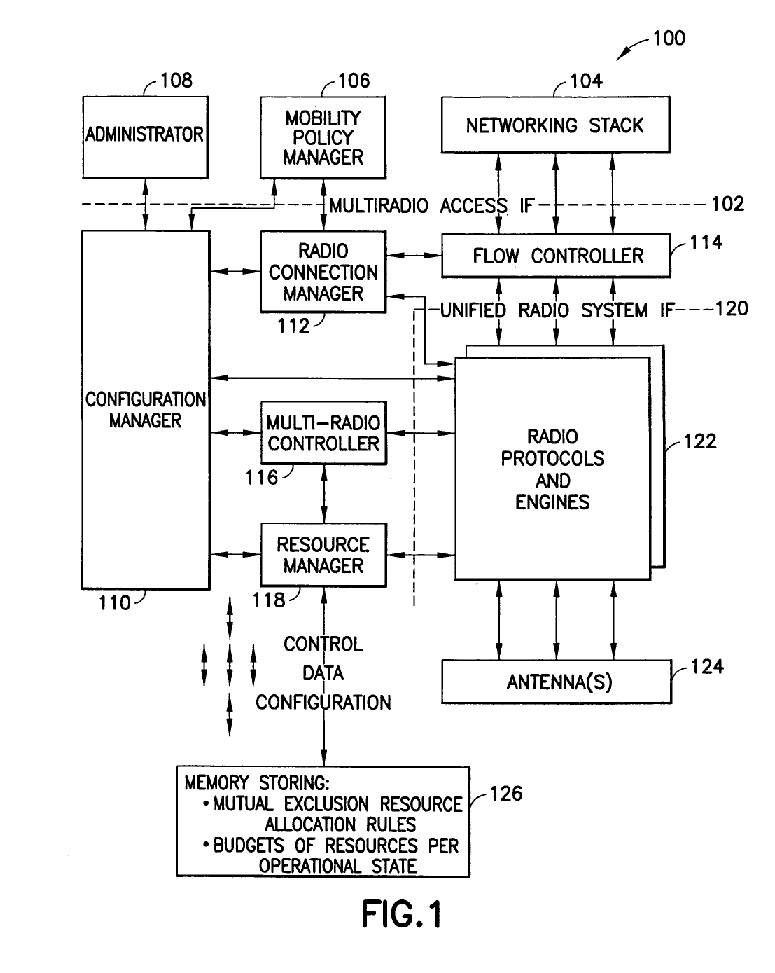

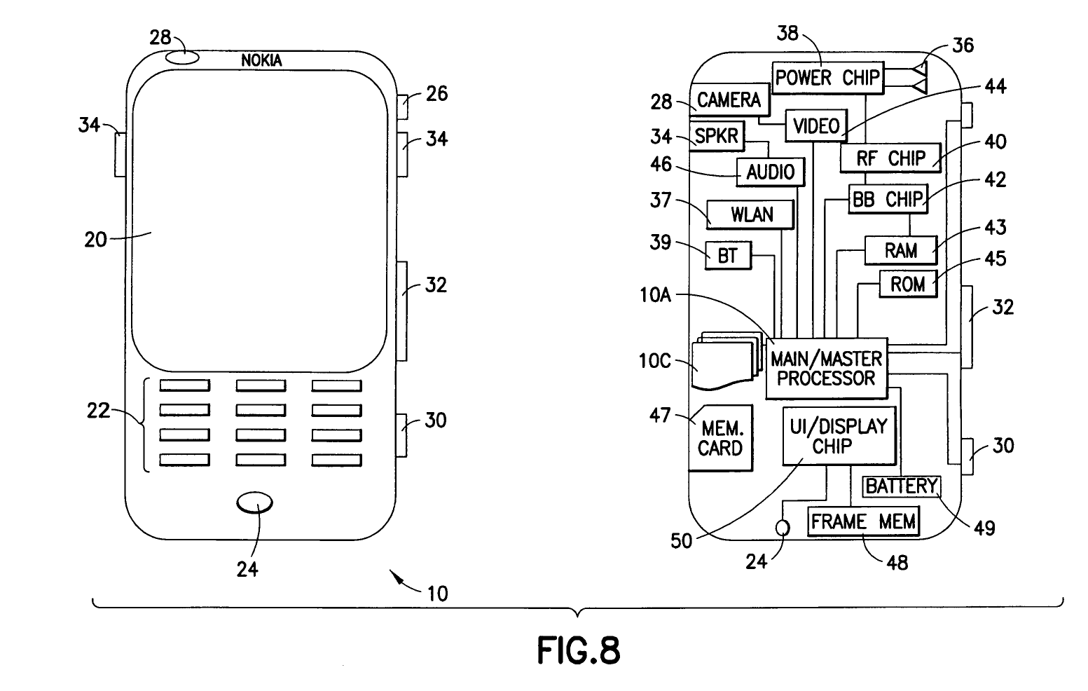

As background to some of the more challenging resource reservation scenarios, consider a streaming application which may be considered as a set of software components, each executing in an iterative way. An application may span several different subsystems of the SDR platform. There are data dependencies between iterations of components. Also, streaming applications are typically controlled by loosely-coupled control software. A particular instance of a streaming application is one particular job or operational state, and an instance of a software component is referred to as a task. In the above WLAN-Bluetooth example, the task is antenna access for the transmission job. Now assume that hardware consists of a multi-processor architecture (FIG. 1 or 8 by example), containing one or more cores of each of one or more types of processing cores. This architecture is potentially partitioned into many subsystems. Each subsystem can have its own Resource Manager (RM). Still further, there is at least one subsystem with a hard real-time RM runtime component that is responsible for admission control and resource reservation based on guaranteed budget satisfaction.

FIG. 1 illustrates a representative but non-limiting functional architecture for a software defined radio SDR 100 according to a particular embodiment of these teachings. SDR simply means that the HW components at least may be re-used for different wireless protocols and different types of radio networks, and to adapt those shared HW components to the different radio standards at the appropriate time instances they are under control of SW and processors (CPU or otherwise) executing the software. All services of the SDR 100 are provided at a Multiradio Access Interface 102. The services may include connectivity and data transfer, but also positioning and broadcasting services. User applications access the SDR computer via a networking stack 104 and mobility policy manager 106, which maintains user preference policies for selecting radios. Additional services for installing new radios into the SDR are available to the administrator user 108. The Multiradio Access Interface 102 is supported by a common SDR control framework, which consists of the Configuration Manager 110, Radio Connection Manager 112, Flow Controller 114, Multiradio Controller 116 and Resource Manager 118 system components. Their functionalities are common to all radio systems and become part of the radio operating system.

This SDR control framework is responsible for installing, loading and activating different radios and their operational states, and for maintaining user data flows, which can also be switched from one radio system to another. The radio operating system OS also does multiradio control 116 and resource management 118 for sharing of available spectrum and radio computer resources among simultaneously executing radio systems. The services of the SDR control framework are available to the radio systems at the Unified Radio System Interface (URSI). With this interface every radio system can be integrated into the SDR computer in a unified manner by making them subject to common multiradio resource management. The Unified Radio System Interface (URSI) 120 includes radio protocols and engines 122 and the air interface is represented as antennas 124. This URSI 120 can be used as reference, when checking the compatibility of individually developed radio system software implementations.

The SDR control framework allows bringing in and removing radio applications during run-time (e.g., while an operational state is active). A set of radio applications may be pre-installed into the SDR 100, and new ones may be brought in by using the administrator services 108 of the Multiradio Access Interface 102. Consider that there are four distinct administrative states, which differ by their use of the shared platform resources. A not installed radio application is unknown by the SDR. In the installed state, the SDR has a copy of the radio system package (including resource budgets and executables for the various operational states that are enabled); it may be stored in mass storage (e.g., such as the memory 120 shown) in compressed format for minimal memory footprint. A loaded radio application is available for the end user, but is not yet in execution. Once an instance (operational state) of the radio application is in execution, it is considered to be in the active state, and issuing various hardware codecs and radio frequency circuitry in addition to the computation, memory and communication resources.

From the resource sharing point of view, the active administrative state is relevant to these teachings. Operational states are defined as sub-states of the active administrative state, and are used to describe different resource requirements. For example, an IEEE 802.11 WLAN station that is in the power-saving mode only needs to process beacon frames sent by the access point, and has no need for any transmitter resources, leaving them for the use of other radio systems. If the access point indicates buffered frames for the station, or the station itself has frames to transmit, transition to normal communication operational state occurs.

Inside an operational state, the radio application is allowed to operate freely within the limits set forth by the resource budget (the resources themselves and the times at which they are reserved). Transitions between operational states originate from the user or an external entity (e.g. radio network), and are requested through the resource manager 118, which is part of the SDR control framework. No real-time guarantees are assured for serving these requests, and the radio system must also accept denied requests to transition from one operational state to another due to resource limitations. In those cases, the application may propagate the deny response (to the request to change operational state) to the Multiradio Access Interface 102 so that the higher level control elements can take the necessary actions (e.g. deactivate lower priority radios, thereby freeing resources). The SDR control framework guarantees resources for only the granted operational states.

The platform neutral SDR functional architecture decomposes the unified radio system 122 into two parts, (radio) protocols and (radio) engines. The protocols part controls the time behavior of the radio system, and the engines part does the radio communication operations at a specific time and with a specific configuration. More specifically, the protocols part takes care of interaction with the user 108 and the external communication partners via antennas 124. It knows the current operational state and detects the need to transition to another, if the resource demand changes between these two operational states. The engines part implements the signal processing and radio frequency functions, as instructed by the protocols part, and contains the accurate time of the radio system. Note that the split between protocols and engines at exemplary FIG. 1 is not according to the operational state information data link layer and physical layer, or real-time properties, or according to platform components; the split is purely functional and allows the unified interface to be used for all radio systems. Other division criteria might lead to non uniform interface description because radio systems differ in the operational state information layer radio functionality distribution and real-time properties.

The URSI 120 harmonizes access of dissimilar radio systems, as well as their behavior on the SDR platform. To this end, all radio systems provide a set of services as specified in the URSI, to be compatible with the SDR functional architecture. They gain access to the shared platform resources and the radio spectrum only by using the SDR control framework services. The services provided by unified radio systems relate to activation and deactivation, neighbor device discovery (other mobile handsets/laptops or network access nodes), and establishing communication and user data flows. Even though mapping of specific radio system functionality to the URSI services may not always be straightforward, the benefit is that all radio systems can be used in the same manner. The SDR control framework services are used by the radio systems to set up the baseband signal processing and radio frequency resources, and subsequently to access the radio spectrum.

Like a conventional computer, the SDR computer/chip has to be able to execute multiple concurrent applications. Radio spectrum is perhaps the most critical scarce resource all active radios need to access. The SDR functional architecture contains a special entity to dynamically schedule access to spectral resources, called the multiradio controller MRC 116. One of its functions is to detect in advance the interoperability problems between simultaneously active radios and solve them, such as for example those noted above. The typical way to solve interoperability problems is to forbid one or more of the radios requesting simultaneously active states from operating in that active state. Such a decision can be based on for example different priorities associated to radios. This leads to the wasted resources noted in background above.

The MRC 116 scheduling concept is a fundamental paradigm change compared to the traditional way where there are separate pairwise coexistence schemes between radios. For example, embodiments according to the described examples allow radios loaded at run time to cooperate cleanly with existing radios. To enable this scenario, radios executed in the SDR platform have two additional functions: 1) The radio has to tell the MRC in advance its temporal requirements and parameters of transmission and reception, and 2) it has to be able to provide its internal time and synchronization information to the MRC. These make up the resource allocation rules for a particular job, and since they are task specific for specific hardware access times per job these allocation rules have a greater granularity than the job-wise radio scheduling conflicts that prior art MRCs addressed. Specifically, for each operational state/job of a radio application, there is a budget of resources needed to satisfy that operational state. The radio requesting that operational state can be granted its request by allocating those resources at the requisite times. For each operational state per radio there is stored in the memory 126, along with the resource allocation rules, a resource budget for each operational state/job. The resource budget itself is hardware independent of the specific hardware arrangement of the host device (e.g., number of processor cycles, bus width, etc. for a WLAN transmit job is the same for different hardware platforms handset model A and handset model B). The resource allocation rules are where the physical constraints of the host device are implemented, since there is where it is shown whether or not job A may be scheduled while job B is running. For example, if the resource allocation rules show that job A is mutually exclusive with job B, even though both jobs A and B require a common resource in their resource budgets, then both jobs can be booked/admitted. Optionally, a radio can be built to utilize scheduling results, for example it may start to prepare retransmission when the MRC denies operation, or go into sleep mode at the end of some granted radio access.

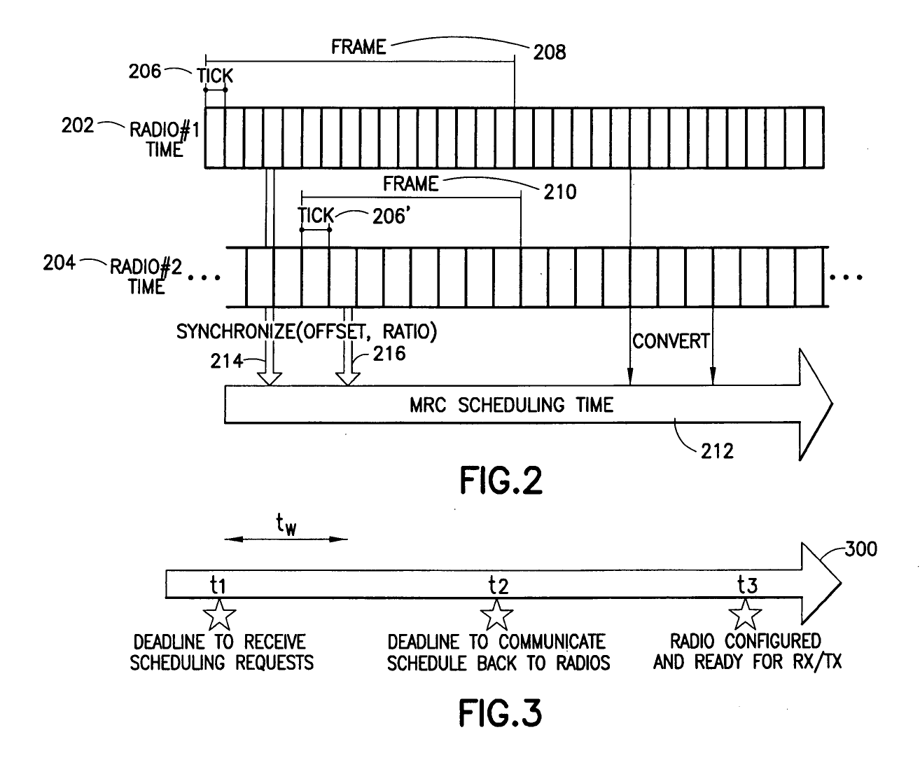

FIG. 2 presents the time concept used for multiradio scheduling. Each individual radio has its own native time. In the SDR control framework, this is often termed “radio time” which in FIG. 2 is shown for two radios, radio #1 time 202 and radio #2 time 204. Radio time is generalized to be constructed from a smaller time unit called a tick 206, 206′, which represent the finest time granularity; and a larger time unit called a frame 208, 210 which represents a repetitive structure used to refer time inside the individual radio. One frame 208, 210 consists of multiple ticks 206, 206′. Both the length of the tick and the number of ticks in one frame can be freely selected for each radio.

To be able to detect spectral conflicts, the MRC converts the radio access start and stop times into its own scheduling time domain 212. By converting to a common MRC time domain, the mutual exclusivity rules are not limited, as in the WLAN-Bluetooth antenna example above, that all cases of frame mis-alignment must provide that a Bluetooth synch word transmission window overlaps a WLAN guard period. The relation between different radio times 202, 204 and a common MRC scheduling time 212 has to be known in advance. In an embodiment each active radio executed in the SDR platform is required to provide the MRC its time synchronization information 214, 216 when the radio is initially started, and to maintain that synchronization during the time the radio is active. This allows the specific hardware access times for different jobs to be normalized so that the resource budgets for those jobs can be compared and determined to be mutually exclusive or not (e.g., for example when the RM and/or MRC seeks to find a way to grant both jobs simultaneously and thereby add a new rule to the mutual exclusive resource allocation rules it already has). Since the frames of different radio systems generally do not maintain steady-state mis-alignment but their mis-alignment changes dynamically (though often predictably), the resource allocation rules themselves can in an embodiment be in the native radio time and the MRC making the resource allocation converts to MRC time to do a proper comparison of allocation accesses prior to admitting another job. The alternative is certainly workable, but there are many more potential jobs which might ask for admission than the few that actually do in a given instance so converting native radio time of the allocation rules into the MRC common time domain upon the MRC's job admissions check is seen to be a bit more efficient implementation.

To be able to accurately detect and solve interoperability problems, the MRC 116 needs to know the characteristics of requested radio operations. Besides timing parameters, any number of the following parameters can be specified for each scheduling request: priority of request; transmitter power; receiver signal quality information (e.g., RSS); channel bandwidth; carrier frequency and crest factor.

Radios are Real-Time (RT) applications. This means that the validity of the computational results depends not only on values, but also on the time at which these are produced. The RT behavior of an application is dependent on the amount of resources available to it during execution. Uncertainty in resource provision may cause unpredictable temporal behavior.

FIG. 3 illustrates a simplified diagram of a multiradio scheduling timeline 300. A scheduling window, t_{w}, defines the window of time for scheduling requests to be solved during one scheduling round. Time t1 defines the deadline for when the MRC 226 receives information about the behavior of radio applications 122 to be able to calculate a schedule during that scheduling round. By time t2, scheduling decisions are communicated back to radio applications 122 in order to have sufficient time to configure the radio HW and/or SW for operation. Time t3 defines when the radio HW and SW should be configured and ready for operation. Time t3 may be earlier than the actual starting time of the radio operation.

The values for these time parameters may be defined depending on the performance of the SDR platform and the ability of the radio applications to accurately estimate their schedule in advance.

In a multiradio system, many radios may of course be active at the same time. Furthermore, each radio can be in one of several different operational states. Each operational state has different resource requirements within the multi-radio device (e.g., HW, SW, spectrum), and therefore a different resource budget. In order to allow maximum flexibility at the lowest cost, radios must share computation, memory and communication resources, as well as hardware resources like RF transceivers and antennas. This poses a difficult problem for any RT system: as satisfaction of the temporal constraints depends on resource availability, resource sharing can make the temporal behavior of each radio depend on the behavior of all other radios in the system, which is difficult to predict in a case such as multi-radio SDR where radio combinations are dynamic.

Embodiments of the invention detailed herein give radios a degree of independence from the rest of the system by using a strong resource management policy, executed by example at the RM 118 or the MRC 116 in conjunction with the RM 118. Conceptually, it is designed to isolate each radio in such a way that the individual radio only sees a fraction of the platform resources, and these are exclusively reserved for it by the RM 118. It is thus a form of virtualization, in that a resource budget is associated with each operational state of a radio. The resource budget lists all resources of the platform that the radio will require once it is in its operational state to meet its RT requirements. But the resource budgets are not specific to the actual HW configuration of the multi-radio device; if jobs A and B each require a certain bus width and the device is updated with another parallel bus doubling the available bus width, the resource budgets do not change but for the case where the mutual exclusivity rules for resource allocation disallow jobs A and B running at overlapping times with the single bus, they may allow both jobs to run at the same time with the added parallel bus.

Such a resource budget is just another term for the high-granularity task-specific resources which need to be allocated for each particular job. Generally in the baseband domain a job consists of the various tasks, which may run on different processors or hardware accelerators (e.g., Viterbi decoder). The signal processing chain can be considered as a series of mathematical functions or tasks, each task performing some function and passes its result/data to the next mathematical function/task. Absent some feedback processing, once a task is completed the resource(s) that were used to complete it is/are free to be allocated to another job, even though other downline tasks of the same job are still in progress. Each task creates processor load, as well as load on communication busses, memory, and so forth. For each job there must be some guarantee of worst-case execution time, otherwise the data being processed is no longer valid. Representing the signal processing, by Synchronous Data Flow (SDF) graphs for example, allows for analyzing these resourcing and timing requirements to meet the worst case execution time guarantee. The processor execution environment can simultaneously admit (allocate resource for) several jobs if it can guarantee resources for all of them at the instances those resources are needed by the simultaneous jobs.

In the overbooking solution according to these teachings, knowing that the resources required by another job which is requesting admittance will not access any resource already allocated to an ongoing job at the same instant (or similarly for two un-allocated jobs seeking overlapping admittance) enables that other requesting job to be scheduled simultaneous with the first (or both jobs to be admitted to overlap in time from a job-wide perspective). This is not to imply that the RM always checks the competing resource budgets against each other; it may be that job A/first operational state is allocated and now job B/second operational state (by a different radio application so there is a time overlap) is being requested, in which case the RM simply looks in the memory for the job B resource budget and checks the resource allocation rules for the resources in the job B budget to see if there is any conflict with the resources allocated to already-running job A. The resources of the job A budget were previously checked against the resource allocation rules when job A was requested and granted. The increased granularity of resource accesses and the access times in the resource budgets and the job-wide allocation rules (e.g., the specific resources and times they are needed per task for all the tasks in a job) assures that these simultaneously running jobs will not in fact conflict since no two tasks have conflicting access times for the same physical resource. The resources are ‘overbooked’ from the prior art job-wise perspective but in truth no specific resource is booked for the same instant for two different jobs because the task-specific rules assure no task overlaps at the same access time allocation.

In an embodiment the resource management policy ensures two things: a) admission control—a radio is only allowed to change operational state if the system can allocate (upon the radio's request) the resource budget it requires for that operational state; and b) guaranteed resource provisions—the access of a radio to its allocated resources cannot be denied by any other radio. It follows then that a change of operational state requested by any individual radio may be rejected by the resource manager 118 by lack of available resources on the platform. Because of this, the resource manager 118 gives no RT guarantees across operational state changes.

A resource budget may contain, for example per task, a list of resource requirements like processor type, required amount of instruction memory, data memory and scheduler settings (e.g. size of time slice on a TDMA scheduler). Furthermore, the channels for inter-task communication have bandwidth and buffer memory requirements. The resource budgets are pre-computed offline per operational state of the radio. The RT components of a radio can be expressed as SDF graphs as is known in the art. This allows for the temporal analysis of execution on a specific platform and calculation of worst-case resource requirements to guarantee compliance to RT demands. For this to be possible, the streaming platform must allow tight bounds on resource usage to be inferred. Resource budget calculation from SDF graphs is known, for example calculating resource budgets between 802.11a WLAN and TD-SCDMA. Algorithms are also known that do the admission control by mapping a vector of such requirements to a vector of provided resources on the platform, which amounts to solving an extension of the vector bin-packing problem.

Different components of a radio application have different RT requirements in terms of strictness and time scale. For example, baseband (BB) and radio frequency RF are essentially hard RT, as a failure in meeting deadlines may cause the output to be worthless (e.g. decoding a WLAN packet must be done within the short-interframe spacing SIFS deadline), while the higher level control protocols can be less strict in meeting their RT constraints. They are also different in terms of the type of computation: the RT baseband processing mostly performs iterative algebraic and bit-manipulation operations over a periodic incoming stream of data, whereas radio protocols are typically communicating finite state machines, exhibiting complex control flow and much more irregular activation patterns.

Because of these different requirements, and also due to vendor specialization, the radio platform is divided into several subsystems, or platform components, each tailored to a specific part of the radio functionality and related to a type of RT requirement. Also, the different type of temporal requirements per platform component means that there may be diversity in the way that resource management is applied to each sub-system. This means that, for instances, the strict timings of the baseband stage may require strict resource budgeting based on the dataflow approach referred to above, while for protocols it may be enough to provide mere estimations of resource requirements and also less strict scheduling algorithms may be used. Due to these considerations, the resource management functionality 118 in the exemplary SDR radio computer platform 100 is distributed in a hierarchical manner.

The central resource manager 118 services operational state change requests, and oversees the platform component resource managers, each of which provides admission control and resource reservation services for its platform component. The platform component resource managers communicate with other entities (e.g. local processor schedulers, memory managers) that actually own the resources and do the fine-grained scheduling.

By example but not by way of limitation, resources are reserved and configured according to an embodiment of the invention in the following steps. First, an admission check is done, without reservation, for all the platform component resource managers. This is to avoid roll back of reservation, if admission on one of the platform components is denied. The platform component resource managers retrieve the operational state specific resource budgets from the radio system description package in the memory 126, if needed. Once admission has been granted on all platform components, the central resource manager 118 proceeds with resource reservation, which includes configuration of the resources. Local dynamic loaders are instructed to request executables from the radio system package in the central repository/memory and store them in a specific position in, e.g., random access memory. In the central resource manager, the operational state change requests for the different radio jobs are queued. The admission check and resource reservation with configuration constitute a single operation.

In accordance with particular embodiments of the invention, there is also defined a mutual exclusivity rule between two tasks. Specifically, jobs A and B are mutually exclusive if while job A is active, job B does not require any resources currently in use by job A (and vice versa). Thus as used herein, mutual exclusivity means the jobs can both be booked (subject to other conflicts with other active or requesting jobs). Such mutual exclusivity rules were introduced above, and form a part of the larger set of resource allocation rules for a particular job. Each job is a set of many tasks and so individual allocation rules within a job are specific to resources required for a particular task of that job. In the prior art, resource allocations were job-wide only and so task A being mutually exclusive with task B meant that they both required use of the some common resource and so if task A is either ready or running then task B must be blocked and that, conversely, if task B is either ready or running, then task A must be blocked. The resource manager 118 according to these teachings that is aware of inter-job conflicts and/or interactions via accessing and comparing the task-specific resources needed according to the resource specific mutual exclusion resource allocation rules of these teachings can inform a sub-system resource manager (e.g., the radio connection manager 112 for the case where the two tasks require different radio connections, or the multi-radio controller 116 for the case where the two tasks require different radio operational states in which connections are not changed) of a mutual exclusion rule which allows the common resource in both jobs' resource budgets to be allocated for both jobs running simultaneously. This will allow the subsystem resource manager 112, 116, 114 to allocate the same resource for each of the jobs, disregarding the resource reservations of the other.

This technique is termed herein ‘resource overbooking’. It requires:
a resource manager 116 with resource reservation oversight;
task mutual exclusivity rules such as those stored in the memory 126 (and accessed/checked either at task start/stop based on some dependency caused by other resource allocation elsewhere—for instance, due to a shared source—or by means of a pre-computed table in the memory 126 that the resource manager 116 accesses;
admission control and/or resource allocation for each one of the tasks, which is by ignoring the resource requirements of any task that is mutual exclusive with it.

This approach makes it such that the resources are effectively overbooked, that is, more resources are reserved (on a job-wise basis) than the resources which are available in the platform. This is not a problem, however, since the tasks will never claim their reserved resources at the same time.

In a radio domain, mutual exclusivity is generally not implicit, as it would be for example in a PC gaming application in which there is a single graphical user interface and so no two interactive streaming games can run at once given the implicit need for each to use that whole interface. The above example for WLAN-Bluetooth antenna conflict is implicit and was first presented as an example for that reason, but many more of the required SDR resources will need explicit mutual exclusivity rules, particularly in the baseband processing regime.

In an embodiment, the RM and/or the MRC of the SDR itself develops the mutual exclusivity rules from the task-specific resource allocation rules. Recall that it is the task-specific resource allocation rules which give the added granularity to the prior art job-wise resource allocation rules. The RM may try different mutual exclusions and select one. For the case where an interference occurs (e.g., data out of a Viterbi decoder is too delayed to be useful when job A is run simultaneous with job B), in an embodiment the RM updates the task-specific rule to stipulate a tighter time frame (a greater access time) for the Viterbi decoder task or for the next downline hardware process task for either or both of those jobs. Once the RM finds a solution that works (where the tasks are mutually exclusive), it stores that newly defined mutual exclusivity rule in its local memory. These different mutual exclusion rule attempts can alternatively be run at compilation time while a new SDR is being tested and where more extensive analysis tools are available, and the resulting rules put in the local memory of each end-use handsets. In either case the rules are stored in the local memory of the SDR.

Note that in an embodiment the jobs or radio applications are unaware of one another, and are also unaware of the mutual exclusivity rules, else designing such jobs would have to take into account all other possible jobs and would be much more complex due to dependencies on other applications. The resource budget for a particular operational state/job lists what resources are required at what times, and the mutual exclusivity rules for a particular multi-radio platform interface the physical configuration of the radio to the different jobs and resource budgets. One handset configuration might have mutual exclusivity rules which allow jobs A and B to run simultaneously while another hardware configuration prohibits it, though the resource budgets for jobs A and B are identical in the local memory of both handsets. The RM, once it determines or finds in its memory which mutual exclusivity rules to use, notifies the MRC, which then implements that mutual exclusivity rule similarly as it does the job-wise radio scheduling/spectrum conflict checks.

In practice, the MRC processes the projected time-behavior of all radio jobs (e.g., by converting into MRC common time), checks the found overlaps against the stored mutual exclusivity rules, and if it spots a conflict (two jobs which have a transmit or receive overlap which is prohibited by a mutual exclusivity rule), it then determines which of those two conflicting jobs or tasks to block or retime in case it is allowed by the radio. In an example, such a re-timing can be re-ordering the time slices at which one or more tasks are performed, within the time constraints of the overall job budget and the time constraints per task noted below. The job is then prohibited from performing that particular conflicting task (or in some cases the job is not admitted at all).

There may be a separate entity which checks the mutual exclusivity rules, or it may be done by the MRC itself, to check that no two mutually exclusive jobs may pass conflicting data or pass activity commands to the allocated resources. The separate entity implementation provides a larger safety margin for badly behaving jobs, and may in enhanced operation utilize the granted/blocked job schedule from the MRC.

Consider an example of this resource overbooking in a time division multiplex TDM task scheduler. In a conventional TDM arrangement, the time division multiplex scheduler allocates a time slice per task, and by necessity in a non-overbooked arrangement the sum of all time slices allocated must not exceed the period P of execution (in practical terms it must be lower). During execution, at the end of the time of a slice, the currently executing task is preempted and the scheduler moves to the next slice.

An overbooking TDM scheme can be obtained by allowing a slice to be skipped in the schedule if the task is not ready to execute when its slice arrives. Furthermore, the sum of allocated slices is allowed to exceed the execution period P, and instead the resource manager 118 (TDM scheduler in this example) checks that the sum of maximum allocated slices per group of non-mutually exclusive tasks is lower than period P. The worst-case time from request to resource provision for any task is still P, since in one complete iteration all the inactive tasks will be skipped.

A real-time scheduler (e.g. operating on principles of earliest deadline first, non-preemptive round robin with worst-case execution times) can operate with its schedule-ability analysis extended such that it takes into account mutual exclusion rules. Conventionally, a schedule-ability test is done by taking into account all other tasks allocated to the processor. Using the overbooking concept, the schedule-ability analysis of each task is allowed to skip any tasks that are mutually exclusive to it.

In another example there is slot allocation on a guaranteed throughput network on a chip (such as for example the Aethereal network on chip architecture described by Goossens, K. et al, in the paper noted in the background section above). The problem is similar to the TDM scheduler problem, but instead of transactions for slice allocations as in the TDM example there would be overbooking of transactions for tasks and slot allocation for the network on chip arrangement described in that paper.

Consider another example for a SDR with the input-output frequency spectrum handled by a multi-radio controller such as shown at FIG. 1 and a strict real-time baseband resource manager. The multi-radio controller 116 assures that the usage of the air interface is allowed to a single radio during the requisite time, because the radios in question use frequency spectrums that interfere with each other. This causes sets of tasks and transactions associated with one radio instance to be mutually exclusive with tasks and transactions associated with another radio instance, on another subsystem, for instance the baseband subsystem. In this exemplary embodiment the multi-radio controller 116 operates as resource manager 118 and communicates these mutual exclusivity rules to the baseband resource manager, thereby enabling the baseband resource manager to do its resource overbooking.

In a particular implementation, the resource manager allocates tasks on different processors and connects them via first-in-first-out FIFO buffers, also checking processing time and other resourcing requirements of the complete job are satisfied. The task scheduler then implements the new schedule.

The RF manager operates similarly and can overbook the same RF resource at the same time. If the shared RF resource is admitted for multiple simultaneous active time-divided radio jobs, the RF resource manager can create its own mutual exclusivity rule which enables the MRC to solve possible temporal conflicts on that shared RF resource.

Of course the RF manager can also implement RF-specific mutual exclusivity rules for RF resources. Both the RF and the baseband ‘subsystem’ resource managers then propose to use some mutual exclusivity rule (as well as other subsystem RMs is present) and some central processor or function checks which one or more of the proposed mutual exclusivity rules are most efficient to complete all of the competing/requesting jobs/tasks. That central function then informs the impacted subsystem resource managers of the decision which mutual exclusivity rule(s) are to be put into use for the present conflicting jobs.

The above examples are specific implementations to explain the concept of resource overbooking. In embodiments of the invention the basic concept above is extended to one or more of the following specific implementations:
In one embodiment the exclusivity rules are for sets of tasks (i.e. set 1 is mutually exclusive with set 2) rather than individual tasks;
In another embodiment the exclusivity rules cover not only tasks, but a number of communication channels between tasks (e.g. when channel A requests bandwidth, channel B does not request bandwidth), or any other resource usage-related transaction that is linked to the execution of the task;
In another embodiment the exclusivity rules are ternary [e.g., set 1 or task 1 is mutually exclusive with set 2 or 3 or task 2 or 3) or even n-ary relations (set/task 1 is mutually exclusive with sets/tasks 2, 3 . . . or n). Similarly, the n-ary relationship may be additive (e.g. set/task 1 is mutually exclusive with set/task 2 and 3; set/task 1 is mutually exclusive with sets/tasks 2, 3 . . . and n).

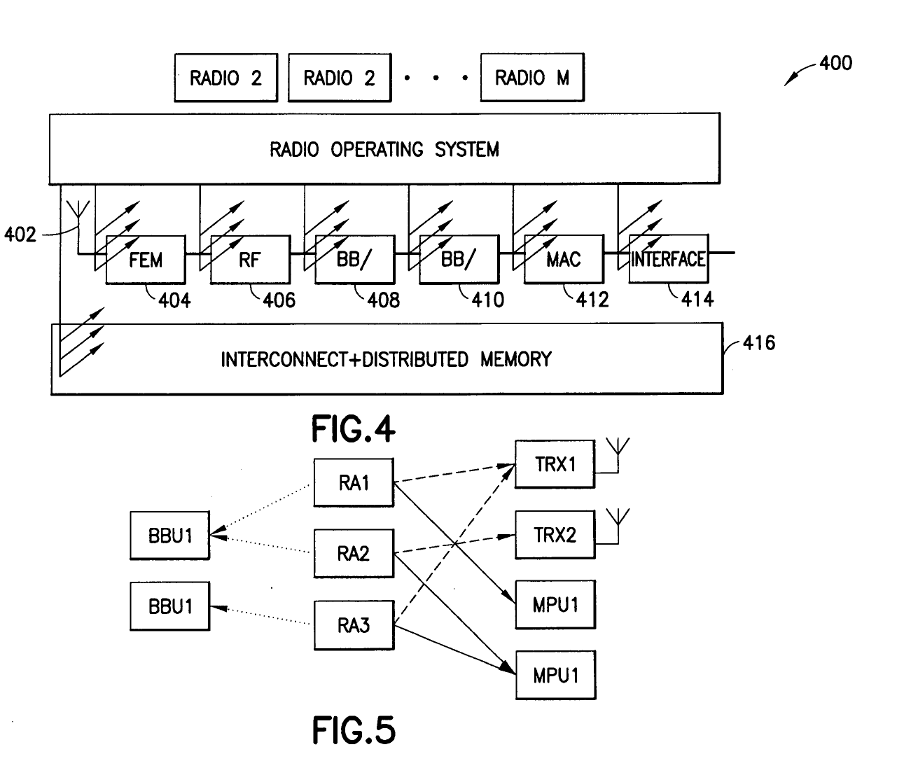

The resource management framework of a multiradio system must provide to each radio, per operational state, a virtual platform which is a subset of the resources of the actual radio computer platform. FIG. 4 illustrates a simplified block diagram of an exemplary radio computer platform 400. It is part of the radio operating system on the radio computer platform The radio computer platform may be conceptualized as a plurality of stages, covering both receive and transmit functions. These stages include one or more antennas 402, front-end modules 404 (FEM) (for example, filters, power amps, etc); RF transceivers 406; baseband processors for modulation/demodulation 408; baseband processors for coding/decoding 410; control processors for protocol stacks 412 (medium access control protocol stack shown by example); and/or application interface units 414.

In active communication, signals are transmitted back and forth with a communication peer. In power save, a mobile handset receives a signal from the peer every now and then (which may be used to indicate a desire for active communication, e.g. a network tells whether a phone call is inbound). If the need arises, the mobile handset transitions into active communication.

The active mode may use both receiver and transmitter resources. The power save mode uses receiver resources (since it listens for a signal from the peer) thereby leaving the transmitter resources for use by other concurrently active radio applications. An executable program in power save mode may also take less space in processors' memories 416, and utilize less communication bus bandwidth. Additionally, power save mode consumes less power than active mode since it is not transmitting. Therefore, the platform resources can be as fine-grained as what can be reasonably measured and allocated.

There is one entity in the SDR which controls the mutual exclusivity rules since different processors may be involved in various scheduling tasks and so cooperative scheduling cannot be used among different radio instances. The end result is distributed preemptive scheduling. For example, meeting the so-called short interframe spacing SIFS deadline (16 μs) of WLAN involves multiple processors. When a DVB-H radio occupies these processors, each of them must be preempted, and the SIFS-related tasks must be scheduled timely. Such tight RT guarantees can only be honored when (tight) upper bounds can be given for the timing of all involved transactions, including inter-processor traffic and memory accesses. In this case a mutual exclusivity rule would not apply since both the WLAN SIFS deadline and the DVB-H reception would need to use at least one same processor at the exact same time, so overbooking is not an option since use of the overlapping processor cannot be delayed for either operational state.

Consider a few more specific examples. In a first RF example, radio B tries to reserve resource Z of RF transceiver for 100% to execute operation B.RX, which has been reserved for 100% for radio A to execute operation A.RX. A mutual exclusion rule which would allow overbooking of resource Z in that instance might be represented as: RF.Z: [(A.RXΘB.RX)]. In a second RF example, radio C tries to reserve resource Z of RF transceiver for 100% to execute operation C.RX, which has been reserved for 100% for radio A to execute operation A.RX and also reserved for 100% for radio B to execute operation B.RX. A mutual exclusion rule which would allow overbooking of resource Z in that instance might be represented as: RF.Z: [(A.RXΘB.RX) and (A.RXΘC.RX) and (B.RXΘC.RX)].

In a first baseband BB example, radio B tries to reserve resource Z (processor cycles) of BB for 80% to execute operation B.RX, which has been reserved for 60% for radio A to execute operation A.RX. A mutual exclusion rule which would allow overbooking of resource Z in that instance might be represented as: BB.Z: [(A.RXΘB.RX)]. In a second BB example, radio C tries to reserve resource Z (e.g., processor cycles) of BB for 40% to execute operation C.RX, which has been reserved for 50% for radio A to execute operation A.RX and also reserved for 35% for radio B to execute operation B.TX. A mutual exclusion rule which would allow overbooking of resource Z in that instance might be represented as: BB.Z: [(A.RXΘC.RX)] or [(A.RXΘB.TX)] or [(B.TXΘC.RX)] or [(A.RXΘB.TX) and (A.RXΘC.RX) and (B.TXΘC.RX)].

FIG. 5 shows a simplified block diagram of an exemplary radio system resource usage. A first radio application RA1 may be in a camping operating state that uses 0.1% of resources for a radio transceiver TRX. A second radio application RA2 may be in a first communication operating state that uses 30% of resources for a TRX. A third radio application RA3 may be in a second communication operating state that uses 50% of resources for a TRX.

To perform operations, radio applications use different types of resources, for example, micro processor unit MPU to run SW algorithms, a baseband BB unit to perform baseband computation, and a radio frequency RF unit to perform RF signal processing, to send and to receive RF messages. The resource classifications (MPU, BB, RF) are used here as non-limiting examples as other classifications are also possible.

Now, at FIG. 5 assume that RA1 is in a non-operational state while RA2 and RA3 need resources for their next requested operational states. RA2 must use BBU1 and MPU2 and TRX2, while RA3 must use BBU2 and MPU2 and TRX1. These are the sets of radio resources which need to be allocated for the requested operational states. There is a seeming conflict with both RA1 and RA2 each needing MPU2 (assume MPU2 has insufficient capacity to satisfy both operational states simultaneously). If the mutual exclusive rule tells that task A, the operational state which RA2 requests, is mutually exclusive with task B, the operational state that RA3 requests; then the seeming incompatible resource allocations can both be booked by the resource manager 118. Such an exclusion rule might allow this example if for example the processing at MPU2 which RA2 needs for task B can be delayed until after the RT requirement of RA2's need for MPU2 for task A. Such an opportunity may arise if for example task B is processing an incoming video stream, which is held in a buffer for some minimum time to assure smooth display to the user; the buffering time can be used to slip the time at which the MPU2 processes that video frame until after task A is done with MPU2. So long as the minimum time allows task B to be accomplished, MPU2 can be effectively overbooked rather than denying, as the prior art would, either task A or task B as requested.

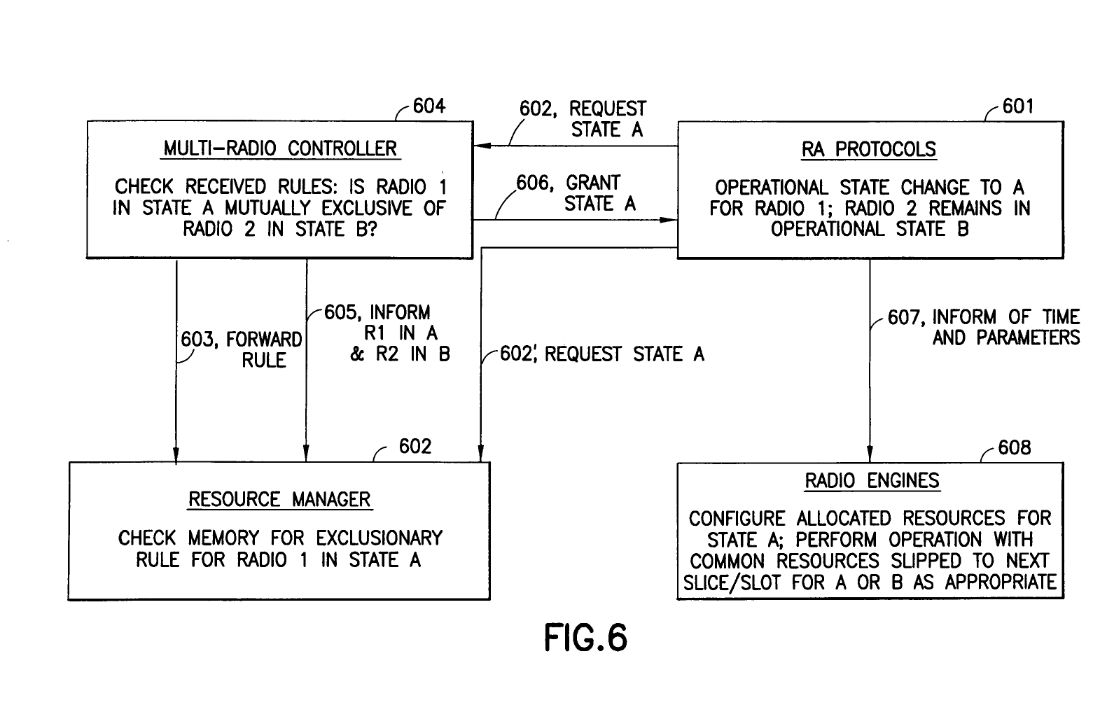

FIG. 6 is a schematic block diagram illustrating an exemplary resource allocation according to resource overbooking. Assume that radio 1 is in an initial operational state and wants to transition to operational state A. At the same time, radio 2 is in operational state B, or is also requesting some change from some current state to operational state B. For state A, radio 1 will need allocated for it resources according to the resource budget of the radio 1 state A. Similarly, radio 2 will need allocated for itself in operational state B the resources that are set forth in the resource budget of the radio 2 state B (e.g., a baseband processing component such as modulator/demodulator/encoder/decoder, or an antenna with a RF receiver or transmitter with or without a particular turbo coder and/or a buffer memory). Now assume that there is at least one resource which is common to both of these resource budgets. The request of radio 1 is such that both state A for radio 1 and state B for radio 2 will be active at the same time, or at least at some time overlap since the radios may not operate on the exact same radio frame and typically will not. The radio protocols and radio engines blocks at FIG. 6 each relate to multiple radios, radio 1 and radio 2 in this example. While the example of FIG. 6 is in the context of radio 2 remaining in state B during the time that radio 1 wants a transition to operational state A, it is readily extended using similar steps from radio 2 for the case where radio 2 also requests an operational state change (to state B).

Now at step 601 the radio protocol for radio 1 determines that it needs an operational state change to state A. At step 602 the radio 1 protocol sends a request for state A to the multi-radio controller, and optionally also at step 602′ to the resource manager. Alternatively the multi-radio controller can inform the resource manager of the radio 1 request 602 it has received. At step 603 the resource manager checks its memory which stores the exclusionary rules and sees that there is a rule for the case where radio 1 is in operational state A, and forwards that rule to the multi-radio controller. At step 604 the multi-radio controller checks the rule it received from the resource manager, sees that state B for radio 2 is mutually exclusive with state A for radio 1 because for each instance of a common resource in the resource budget of radio 1 state A and the resource budget of radio 2 state B, there is a mutual exclusion rule allowing both radio states to operate simultaneously. The multi-radio controller at step 605 then informs the resource manager that radio 1 will be in state A while radio 2 will be in state B (so the resource manager can assure those resources are allocated and not also allocate them to another for which overbooking is not an option), and at step 606 grants/allocates to radio 1 operational state A. Finally at step 607 the radio protocol for radio 1 informs the radio engine for radio 1 of the time and parameters. The loop is completed at step 608 whereby the radio engine for radio 1 configures the allocated resources of the first resource set for radio 1, and for each radio resource that is common to both the first resource set of radio 1 and the second resource set of radio 2, the operation for the respective state A or state B performed by that overbooked common resource is slipped to the next time slice or slot.

The procedures set forth at FIG. 6 are exemplary of the overbooking process, and other process steps may be used to implement the resource overbooking without departing from these teachings.

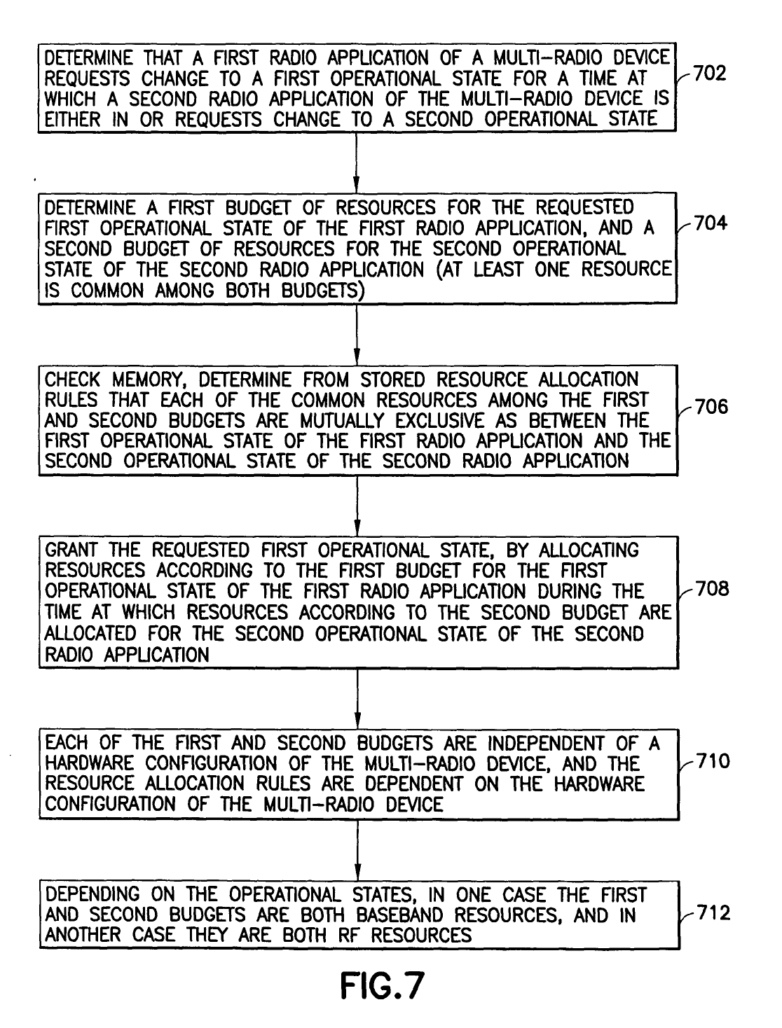

FIG. 7 is logic flow diagram that illustrates the operation of a method of operation for a radio application, and a result of execution of computer program instructions which may be embodied on a computer readable memory, in accordance with the exemplary embodiments of this invention. In accordance with these exemplary embodiments of this method, at block 702, determining that a first radio application of a multi-radio device requests change to a first operational state for a time at which a second radio application of the multi-radio device is either in a second operational state or requests a change to the second operational state. At block 704 there is determined a first budget of resources for the requested first operational state of the first radio application, and there is also determined a second budget of resources for the second operational state of the second radio application. Note that these two resource budgets need not be determined from the same access of the memory; they can be done individually at the time each radio requests their respective operational state for example. For blocks 702 and 704, there is at least one resource in common among the first budget and the second budget, and there is some time overlap among the first operational state and the second operational state.

Further at FIG. 7, at block 706 the multi-radio device determines from resource allocation rules which are stored in that memory that each of the common resources among the first and second budgets are mutually exclusive as between the first operational state of the first radio application and the second operational state of the second radio application. Then at block 708, as a result of the determining done at block 706, the requested first operational state of the first radio application is granted, which is evidenced by allocating resources according to the first budget for the first operational state of the first radio application during the time at which resources according to the second budget are allocated for the second operational state of the second radio application.

Additional elements of FIG. 7 illustrate more specific embodiments, and these may be combined with the above blocks individually or in combination. At block 710 each of the first and second budgets are independent of a hardware configuration of the multi-radio device, and the resource allocation rules are dependent on the hardware configuration of the multi-radio device. At block 712 the first and second budgets are baseband resources (e.g., processor cycles, bus requirements, memory requirements), and in another embodiment the first and second budgets are RF resources (e.g., processing blocks along the signal processing pathway between the antenna and the analog-to-digital converter ADC or the digital-to-analog converter DAC, depending on RX or TX direction).

The method according to FIG. 7 can be executed by a resource manager or a multi-radio controller of a software defined radio. In another embodiment noted above it may be executed by a baseband controller of a software defined radio, and the at least one common resource comprises at least one of modulating, demodulating, encoding and decoding, which of course are all at baseband given that a baseband controller is executing this particular implementation. In another implementation the method of FIG. 7 is executed by a time division multiple resource manager in which the at least one common resource among the first budget and the second budget is used by only one of the first and second radio application after skipping a time slice in the allocated radio resources. And in still another implementation the method of FIG. 7 is executed by a network on chip device in which the at least one resource in common among the first budget and the second budget is used by only one of the first and second radio application after skipping a task or slot allocation in the allocated resources.

The various blocks shown in FIG. 7 may be viewed as method steps, and/or as operations that result from operation of computer program code, and/or as a plurality of coupled logic circuit elements constructed to carry out the associated function(s).

According to the above detailed embodiments, one particular technical effect of these teachings is the in a SDR the baseband computational resources can be used more efficiently when it is known that two or more radio systems cannot transmit and/or receive at the same time due to some particular resource conflict existing between them (e.g., using the same RF transmitter chain, interference reasons, etc.). One typical situation might be that a cellular radio is only listening for the control channel for a very short period every once in a while, while another more active radio is utilizing the same resources for communication between the cellular time slots.

The computer readable memory 126 shown at FIG. 1 may be of any type suitable to the local technical environment and may be implemented using any suitable data storage technology, such as semiconductor based memory devices, flash memory, magnetic memory devices and systems, optical memory devices and systems, fixed memory and removable memory. The various processors (or portions of a stand-alone processor) shown at FIG. 1 (e.g., resource manager, multi-radio controller, etc.) maybe of any type suitable to the local technical environment, and may include one or more of general purpose computers, special purpose computers, microprocessors, digital signal processors (DSPs) and processors based on a multicore processor architecture, as non-limiting examples.

Consistent with the exemplary embodiments of this invention, reference is made to FIG. 8 for illustrating a simplified block diagram of a SDR according to a specific embodiment. The SDR may be a user equipment UE, and in general, the various embodiments of the UE can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

FIG. 8 illustrates representative but non-limiting detail of an exemplary UE in both plan view (left) and sectional view (right), and the invention may be embodied in one or some combination of those more function-specific components. At FIG. 8 the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 32 which may alternatively function as a volume adjustment for the speaker(s) 34 when the camera 28 is not in an active mode.

Within the sectional view of FIG. 8 are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and down-converts the signal for baseband processing. The baseband (BB) chip 42 detects the signal which is then converted to a bit-stream and finally decoded. Similar processing occurs in reverse for signals generated in the apparatus 10 and transmitted from it. The RF chip and the BB chip may be considered separate processors or controllers, or they may be components or functional portions of a more robust multi-function processor or controller.

Signals to and from the camera 28 pass through an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which the various computer readable software programs 10C are stored. All of these components within the UE 10 are normally powered by a portable power supply such as a battery 49.

The aforesaid processors 38, 40, 42, 44, 46, 50, if embodied as separate entities in a UE 10, may operate in a slave relationship to the main processor 10A, which may then be in a master relationship to them. Embodied software implementations of the invention may be disposed across various chips and memories as shown or disposed within another processor that combines some of the functions described above for FIG. 8. Any or all of these various processors of FIG. 8 access one or more of the various memories, which may be on-chip with the processor or separate therefrom.

Note that the various chips (e.g., 38, 40, 42, etc.) that were described above may be combined into a fewer number than described and, in a most compact case, may all be embodied physically within a single chip.

The functional components of FIG. 1, e.g., the multi-radio controller, the resource manager, the radio protocols and engines, may be embodied as hardware such as in one or more of the processors/chips shown at FIG. 8, or as software/firmware executed by one or more of those processors/chips, or as some combination of any of software, firmware and/or hardware.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

1. A method, comprising:
at least one processor determining that a first radio application of a multi-radio device requests change to a first operational state for a time at which a second radio application of the multi-radio device is in a second operational state or requests change to a second operational state;
the at least one processor accessing a memory to determine a first budget of resources for the requested first operational state of the first radio application, and a second budget of resources for the second operational state of the second radio application;
for the case in which there is at least one common resource among the first budget and the second budget, the at least one processor determining from resource allocation rules stored in the memory that each of the common resources are mutually exclusive as between the first operational state of the first radio application and the second operational state of the second radio application; and
as a result of the determining from the resource allocation rules, granting the request of the first radio application by allocating resources according to the first budget for the first operational state of the first radio application during the time at which resources according to the second budget are allocated for the second operational state of the second radio application.

2. The method according to claim 1, in which each of the first and second budgets are independent of a hardware configuration of the multi-radio device, and the resource allocation rules are dependent on the hardware configuration of the multi-radio device.

3. The method according to claim 1, in which the first radio application for the first operational state actively uses the at least one common resource at a different time than the second radio application for the second operational state.

4. The method according to claim 1, in which:
the first and second budgets each comprise task-specific resources for executing a specific task of the respective first and second operational states, in which each of the first and second operational states comprise a series of tasks;
the resource allocation rules are task specific as to radio application and operational state; and
the at least one processor determines from the resource allocation rules that each of the common resources are mutually exclusive by checking, for each task-specific resource of the first budget for the first radio application and the first operational state, that the said task-specific resource is mutually exclusive of any task-specific resource of the second budget for the second radio application and the second operational state.

5. The method according to claim 1, in which the at least one processor comprises a resource manager which receives the request from a second processor having control over the first operational state, and the resource manager grants the request by sending a signal to the second processor;
and in which the multi-radio device comprises a software-defined radio.

6. The method according to claim 1, in which each of the first and the second budgets comprise baseband resources.

7. The method according to claim 6, in which each of the first and the second budgets comprise at least: baseband radio resources; processor cycles; bus requirements; and memory requirements.

8. The method according to claim 1, in which each of the first and the second budgets comprise RF resources

9. The method according to claim 1, in which determining from the resource allocation rules that each of the common resources are mutually exclusive comprises:
the at least one processor first determining from the resource allocation rules that at least one of the common resources are not mutually exclusive as between the first operational state of the first radio application and the second operational state of the second radio application;
the at least one processor calculating that tasks which comprise at least one of the first and second budgets can be re-ordered or slipped in time such that each of the common resources which were first determined to be not mutually exclusive will not be simultaneously accessed by the first operational state of the first radio application and the second operational state of the second radio application after the re-ordering or slipping in time; and
the at least one processor then storing in the memory a new resource allocation rule descriptive of the re-ordering or slipping in time, and determining from the new resource allocation rule that each of the common resources first determined to be not mutually exclusive are now mutually exclusive.

10. The method according to claim 1, in which determining from the resource allocation rules that each of the common resources are mutually exclusive comprises:
the at least one processor first determining from the resource allocation rules that at least one of the common resources are not mutually exclusive as between the first operational state of the first radio application and the second operational state of the second radio application;
the at least one processor detecting when a task of the first radio application and a task of the second radio application overlap in time; and
the at least one processor preventing either one or other of the overlapping tasks at least during the overlap in time.

11. A memory storing computer readable instructions that when executed by a processor perform operations comprising:
determining that a first radio application of a multi-radio device requests change to a first operational state for a time at which a second radio application of the multi-radio device is in a second operational state or requests change to a second operational state;
accessing a memory to determine a first budget of resources for the requested first operational state of the first radio application, and a second budget of resources for the second operational state of the second radio application;
for the case in which there is at least one common resource among the first budget and the second budget, the at least one processor determining from resource allocation rules stored in the memory that each of the common resources are mutually exclusive as between the first operational state of the first radio application and the second operational state of the second radio application; and
as a result of the determining from the resource allocation rules, granting the request of the first radio application by allocating resources according to the first budget for the first operational state of the first radio application during the time at which resources according to the second budget are allocated for the second operational state of the second radio application.

12. The memory according to claim 11, in which each of the first and second budgets are independent of a hardware configuration of the multi-radio device, and the resource allocation rules are dependent on the hardware configuration of the multi-radio device.

13. An apparatus comprising at least one processor for a multi-radio device and a memory storing resource allocation rules, in which:
the at least one processor is configured to determine that a first radio application of the multi-radio device requests change to a first operational state for a time at which a second radio application is in a second operational state or requests the second operational state;
the at least one processor configured to access the memory to determine a first budget of resources for the requested first operational state of the first radio application and to determine a second budget of resources the second operational state of the second radio application;
for the case in which there is at least one common resource among the first budget and the second budget, the at least one processor determining from the stored resource allocation rules that each of the common resources are mutually exclusive as between the first operational state of the first radio application and the second operational state of the second radio application; and
as a result of the determining from the resource allocation rules, the at least one processor is configured to grant the request of the first radio application by allocating resources according to the first budget for the first operational state of the first radio application during the time at which resources according to the second budget are allocated for the second operational state of the second radio application.

14. The apparatus according to claim 13, in which each of the first and second budgets are independent of a hardware configuration of the multi-radio device, and the resource allocation rules are dependent on the hardware configuration of the multi-radio device.

15. The apparatus according to claim 13, in which:
the first and second budgets each comprise task-specific resources for executing a specific task of the respective first and second operational states, in which each of the first and second operational states comprise a series of tasks;
the resource allocation rules are task specific as to radio application and operational state; and
the at least one processor is configured to determine from the resource allocation rules that each of the common resources are mutually exclusive by checking, for each task-specific resource of the first budget for the first radio application and the first operational state, that the said task-specific resource is mutually exclusive of any task-specific resource of the second budget for the second radio application and the second operational state.

16. The apparatus according to claim 13, in which the at least one processor comprises a resource manager which is configured to receive the request from a second processor having control over the first operational state, and the resource manager is configured to grant the request by sending a signal to the second processor;
and in which the apparatus comprises the multi-radio device which comprises a software-defined radio.

17. The apparatus according to claim 13, in which each of the first and the second budgets comprise baseband resources.

18. The apparatus according to claim 13, in which each of the first and the second budgets comprise RF resources.

19. The apparatus according to claim 13, in which the at least one processor is configured to determine from the resource allocation rules that each of the common resources are mutually exclusive by:
the at least one processor first determining from the resource allocation rules that at least one of the common resources are not mutually exclusive as between the first operational state of the first radio application and the second operational state of the second radio application;
the at least one processor calculating that tasks which comprise at least one of the first and second budgets can be re-ordered or slipped in time such that each of the common resources which were first determined to be not mutually exclusive will not be simultaneously accessed by the first operational state of the first radio application and the second operational state of the second radio application after the re-ordering or slipping in time; and
the at least one processor then storing in the memory a new resource allocation rule descriptive of the re-ordering or slipping in time, and determining from the new resource allocation rule that each of the common resources first determined to be not mutually exclusive are now mutually exclusive.

20. The apparatus according to claim 13, in which determining from the resource allocation rules that each of the common resources are mutually exclusive comprises:
the at least one processor first determining from the resource allocation rules that at least one of the common resources are not mutually exclusive as between the first operational state of the first radio application and the second operational state of the second radio application;
the at least one processor detecting when a task of the first radio application and a task of the second radio application overlap in time; and
the at least one processor preventing either one or other of the overlapping tasks at least during the overlap in time.
